(19) United States
(12) Patent Application Publication
(10) Pub. No.: US 2015/0202551 A1
(43) Pub. Date: Jul. 23, 2015

(54) Filtration candle to facilitate inspection

(71) Applicant: Gilles Larouche, St-Honore (CA)

(72) Inventor: Gilles Larouche, St-Honore (CA)

(21) Appl. No.: 14/158,929

(22) Filed: Jan. 20, 2014

(51) Int. Cl. B01D 29/13

(52) U.S. Cl. CPC B01D 29/13

(57) ABSTRACT

An improved filtration candle comprises at least one filtration candle, wherein each filtration candle comprises an elongated filtration sleeve including a threaded male neck on one distal end thereof, an elongated perforated casing including attachment members on one distal end adapted to removably attach to the one distal end of the filtration sleeve, and three supports located on an opposite distal end extending radially inward to a center axial point thereof, such that the perforated casing is adapted to slide over a substantial length of the filtration sleeve until an opposite distal end of the filtration sleeve makes contact with the three supports and the attachment members are attached to the one distal end of the filtration sleeve. An inspection cap removably attached to the opposite distal end of the perforated casing is adapted to be removed when inspection of the filtration sleeve is desired. A candle holder that is adapted to hold at least one filtration candle having at least one threaded female neck adapted to removably attach to a threaded male neck of each respective filtration candle such that the filtration candle apparatus is adapted to filter liquid passing therethrough, and such that the filtration sleeve can be easily inspected and replaced when desired.

### FIELD OF THE INVENTION

The present invention relates generally to a filtration candle but more particularly to an improved filtration candle to facilitate inspection.

### BACKGROUND OF THE INVENTION

The water we receive in our homes undergoes a series of filtrations and other processes to remove impurities before it arrives at our taps. Whether water is drawn from a well or sprayed from a faucet, it is not always fit for human consumption. In some cases, it is even dangerous. Commercial filtration systems solve this issue, as it separates contaminants in the water from the fluid. There are various methods that exist, but the goal of most of them is usually to filter harmful substances from water. The Funda filter for example uses long candles in a pressurized system for filtration while the Dorr-Oliver disc filters use round discs made up of pie shaped filters. These filters separate solid particles from liquid. They get caked regularly and require scheduled cleaning and maintenance. The filter candles and pie-shaped filters need to be physically removed from their holders in order to clean, replace elements or have their screens changed. This is a time consuming process which is partly due to the method in which the candles are attached to the holders and partly due to the process involved in removing and fitting new screens on the candles and other filter elements. There hence exists a need for a better method of inspecting candles with faster removal and a more efficient candle design to aid faster screen changes.

### SUMMARY OF THE INVENTION

In view of the foregoing disadvantages inherent in the known devices now present in the prior art, the present invention, which will be described subsequently in greater detail, is to provide objects and advantages which are:

To provide for an improved filtration candle that allows faster removal and attachment of filtration screens.

It is a further advantage of the invention to provide for an inspection cap that can be easily removed to inspect the condition of the candle and reduce the time taken for maintenance.

In order to do so, the invention comprises at least one filtration candle, wherein each filtration candle comprises an elongated filtration sleeve including a threaded male neck on one distal end thereof, an elongated perforated casing including attachment members on one distal end adapted to removably attach to the one distal end of the filtration sleeve, and three supports located on an opposite distal end extending radially inward to a center axial point thereof, such that the perforated casing is adapted to slide over a substantial length of the filtration sleeve until an opposite distal end of the filtration sleeve makes contact with the three supports and the attachment members are attached to the one distal end of the filtration sleeve. An inspection cap removably attached to the opposite distal end of the perforated casing is adapted to be removed when inspection of the filtration sleeve is desired. A candle holder that is adapted to hold at least one filtration candle having at least one threaded female neck adapted to removably attach to a threaded male neck of each respective filtration candle such that the filtration candle apparatus is adapted to filter liquid passing therethrough, and such that the filtration sleeve can be easily inspected and replaced when desired.

The improved filtration candle apparatus has the attachment members of the perforated casing made out of mechanical screws.

Preferably, the perforated casing and the three supports of the perforated casing are formed from metal.

The filtration candle apparatus is formed from a material chosen from a group of materials comprising plain steel, alloyed steel, bronze, copper, and aluminum.

The perforated casing includes perforations formed in circular shapes.

The perforations are formed in a plurality of offset rows around the entire circumference thereof.

The candle holder has a an elongated tubular shape and is adapted to allow the liquid to pass therethrough, and further includes a removable cap on each end of the tubular shape, such that the liquid can pass through either end thereof when desired.

The candle holder includes at least one bracket portion thereon adapted to allow the apparatus to be securely and removably held to a structural member.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Isometric views of a prior art candle holder.

FIGS. 2a-b, Isometric view of the invention, and detail thereof.

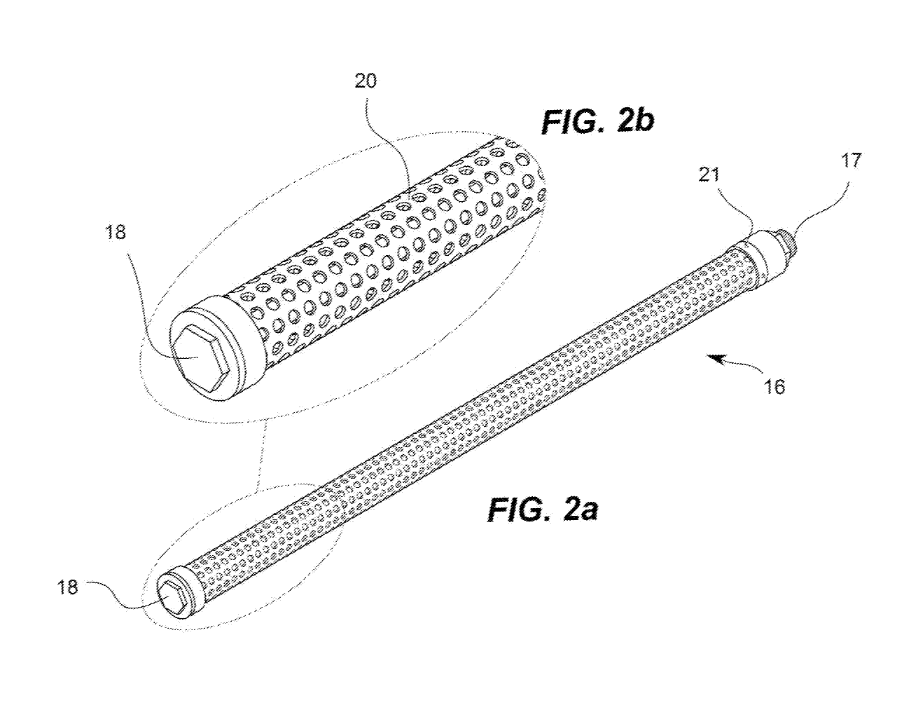

FIG. 3 Side view of improved candle and face view of bottom cap.

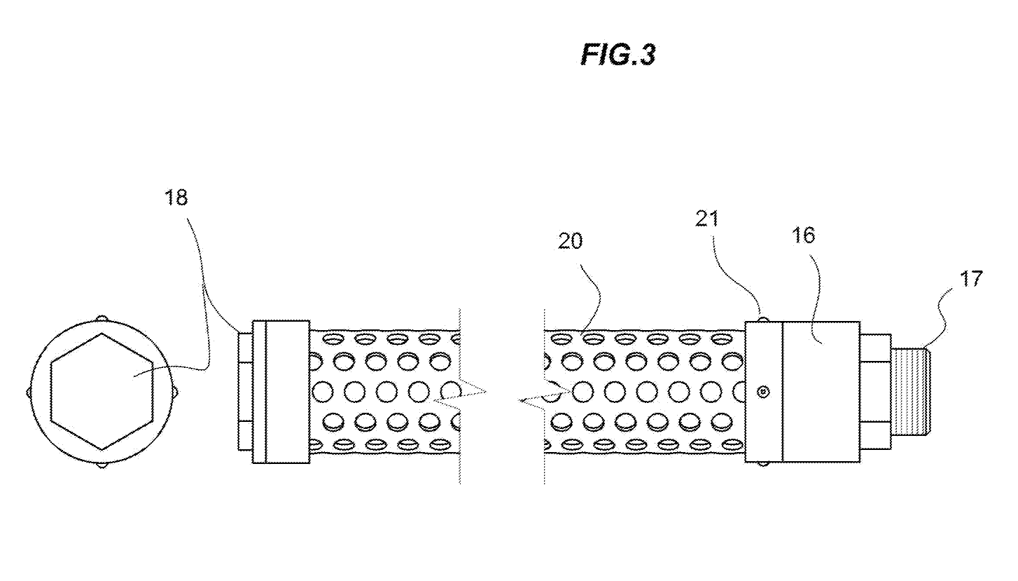

FIG. 4a-b Exploded view of invention and cross-section view of improved candle.

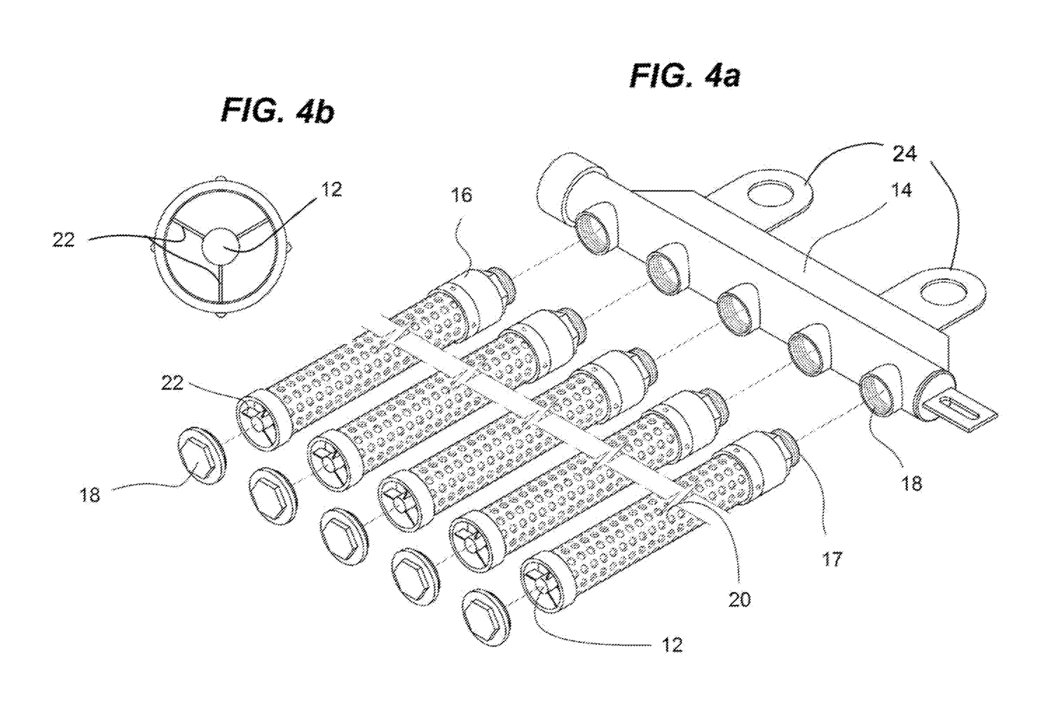

FIG. 5 Isometric view of invention.

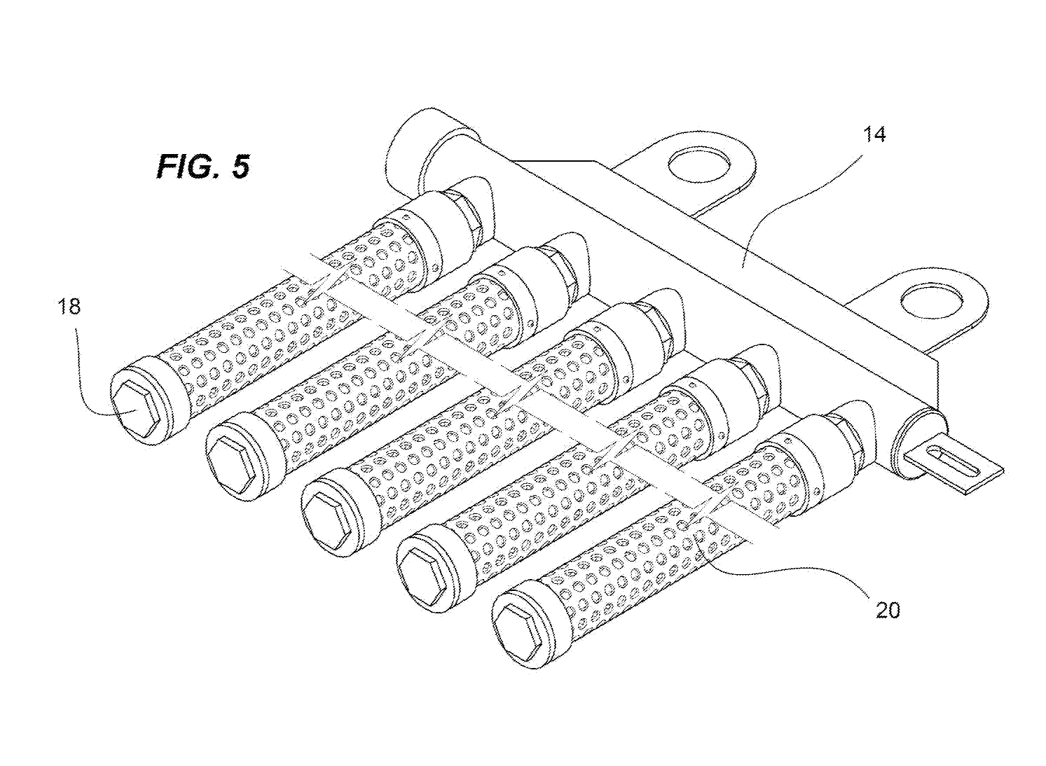

### DETAILED DESCRIPTION OF THE PREFERRED EMBODIMENT

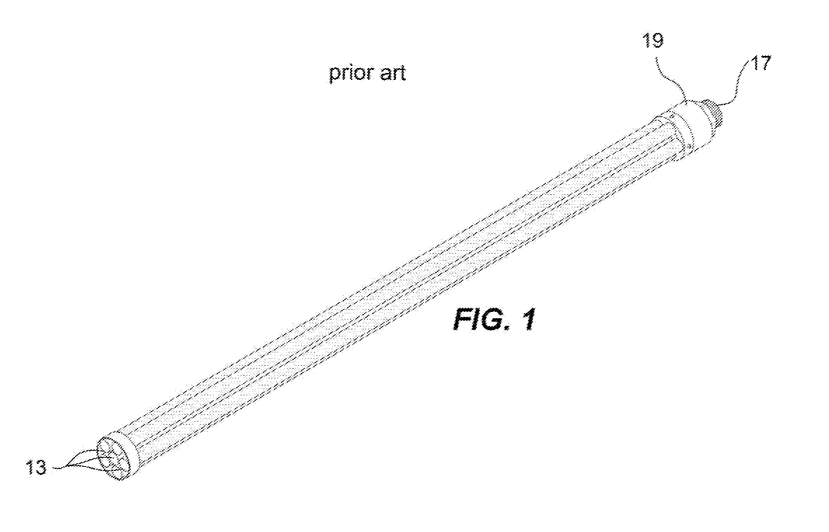

A filtration system of the prior art, as seen in FIG. 1, uses a filtration candle member (19) with six filtration sleeves (13) and a male threaded neck (17)

An improved filtration candle (16) comprised of a single filtration sleeve (12) encased in a perforated metal casing (20) with the male threaded neck (17) at one end of the filtration candle (16) which screws onto threaded female neck (18) which forms part of a candle holder (14). The perforated metal casing (20) is attached to one end of the filtration candle (16) via screws (21) and attached at the other end to the single filtration sleeve (12) via three metal supports (22). The filtration candle (16) is closed with an inspection cap (18) at the bottom, and which can be removed to verify the condition of the single filtration sleeve (12) and the interior of the filtration candle (16). A filtration screen (not shown) slips over the perforated metal casing (20) and is sealed to complete the setup. Also, an attachment bracket (24) extending integrally from the candle holder (14) allows it to be attached to a structural member.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An improved filtration candle apparatus comprising:
at least one filtration candle, wherein each said at least one filtration candle comprises an elongated filtration sleeve including a threaded male neck on one distal end thereof, an elongated perforated casing including attachment members on one distal end adapted to removably attach to said one distal end of said filtration sleeve, and three supports located on an opposite distal end extending radially inward to a center axial point thereof, such that said perforated casing is adapted to slide over a substantial length of said filtration sleeve until an opposite distal end of said filtration sleeve makes contact with said three supports and the attachment members are attached to said one distal end of said filtration sleeve, and an inspection cap removably attached to said opposite distal end of said perforated casing and is adapted to be removed when inspection of said filtration sleeve is desired;
and a candle holder adapted to hold at least one filtration candle, said candle holder including at least one threaded female neck adapted to removably attach to a threaded male neck of each respective said at least one filtration candle,
such that said filtration candle apparatus is adapted to filter liquid passing therethrough, and such that said filtration sleeve can be easily inspected and replaced when desired.

2. The improved filtration candle apparatus of claim 1, wherein said attachment members of said perforated casing are formed as mechanical screws.

3. The improved filtration candle apparatus of claim 1, wherein said perforated casing and said three supports of said perforated casing are formed from metal.

4. The improved filtration candle apparatus of claim 1, wherein said filtration candle apparatus is formed from a material chosen from a group of materials comprising plain steel, alloyed steel, bronze, copper, and aluminum.

5. The improved filtration candle apparatus of claim 1, wherein said perforated casing includes perforations formed in circular shapes.

6. The improved filtration candle apparatus of claim 5, wherein said perforations are formed in a plurality of offset rows around the entire circumference thereof.

7. The improved filtration candle apparatus of claim 1, wherein said candle holder has a an elongated tubular shape and is adapted to allow said liquid to pass therethrough, and further includes a removable cap on each end of said tubular shape, such that said liquid can pass through either end thereof when desired.

8. The improved filtration candle apparatus of claim 1, wherein said candle holder includes at least one bracket portion thereon adapted to allow said apparatus to be securely and removably held to a structural member.
